(19) United States
(12) Patent Application Publication
(10) Pub. No.: US 2016/0104316 A1
(43) Pub. Date: Apr. 14, 2016

(54) USE OF BORDERLINES IN URBAN 3D-MODELING

(71) Applicant: GEOSIM SYSTEMS LTD., Petach Tikva (IL)

(72) Inventors: VICTOR SHENKAR, RAMAT GAN (IL); YIGAL EILAM, KIRIAT ONO (IL)

(73) Assignee: GEOSIM SYSTEMS LTD., Petach Tikva (IL)

(21) Appl. No.: 14/787,276

(22) PCT Filed: Apr. 28, 2014
(86) PCT No.: PCT/IB2014/061046

§ 371 Date: Oct. 27, 2015

Related U.S. Application Data
(60) Provisional application No. 61/816,755, filed on Apr. 28, 2013.

(51) Int. Cl. G06T 17/05; G06T 17/20

(52) U.S. Cl. CPC G06T 17/05; G06T 17/20; G06T 2207/10028

(57) ABSTRACT

A method for generating a 3D-model of an urban environment including: identifying a first plurality of border lines where each border line substantially circumferences a sub-area within the urban environment; generating a 3D-model for the urban sub-areas; generating a 3D-model for an complementary area of the urban environment, the complementary area the border lines and the area between the border lines and excluding the urban sub-areas; merging the 3D-models of the sub-areas with the 3D-model of the complementary area to form said 3D-model of the urban environment.

### CROSS-REFERENCE TO RELATED APPLICATIONS

This application claims the benefit of priority of U.S. Provisional Patent Application No. 61/816,755, filed Apr. 28, 2013, the disclosure of which is incorporated herein by reference in its entirety.

### FIELD OF THE INVENTION

The present invention relates to creating a three dimensional model of a large physical entity and, more particularly, but not exclusively to fusing together a plurality of three dimensional models, which together represent a large physical entity.

### BACKGROUND OF THE INVENTION

It is well known in the art to produce a three-dimensional (3D) model of a physical entity. Producing a 3D-model of a large-scale entity typically require the fusing of several 3D-models where each model represents part of a large-scale entity. Each of the partial 3D-models is typically derived from scanning data such a point-cloud. A point-cloud can be produced by a probing device, which probes the surface of a physical object. Such probing can be tactile, optical, electro-magnetic, etc. The 3D probing machine, namely a scanner, and typically a laser-scanner, creates a set of 3D points, namely a point-cloud, describing the shape and/or surface features of the object.

Creating a point-cloud for a large object or entity (these terms can be used in this documents interchangeably unless differentiated explicitly), such as a building or an urban environment, requires a large number of scans producing a large number of partial or local point-clouds. The point clouds, or the 3D-models produced from the point clouds, have to be fused together to create a complete or global point-cloud of the large-scale entity, or a global 3D-model of the large-scale entity. Any measurement, including scanning, produces an error and when several point-clouds or their 3D-models are merged (or fused) together their respective errors add up.

There is thus a widely recognized need for, and it would be highly advantageous to have, a system and a method for fusing a plurality of partial 3D-models of a large-scale entity into an accurate global 3D-model of a large-scale entity devoid of the above limitations.

### SUMMARY OF THE INVENTION

According to one aspect of the present invention there is provided a method for generating a 3D-model of an urban environment, the method including the steps of identifying a plurality of border lines, where each border line delineates an a sub-area of the urban environment, generating a 3D-model for a sub-area enclosed by one of the border lines, generating a 3D-model for complementary area, where the complementary area is a part of the urban environment not enclosed by any of the borderlines, and merging the 3D-models of the sub-areas within the 3D-model of the complementary area to form the 3D-model of the urban environment.

According to another aspect of the present invention there is provided a method for generating a 3D-model of an urban environment where the border line is drawn according to a plurality of ground level physical objects identified within the urban environment.

According to yet another aspect of the present invention there is provided a method for generating a 3D-model of an urban environment additionally including a step of generating a 3D-model of a borderline system, where the borderline system includes the plurality of border lines.

According to still another aspect of the present invention there is provided a method for generating a 3D-model of an urban environment where the 3D-model for a sub-area of the urban environment is generated according to the borderline enclosing the sub-area and where the borderline is part of the 3D-model of the borderline system.

According to another aspect of the present invention there is provided a method for generating a 3D-model of an urban environment where the 3D-model of the complementary area of the urban environment is generated according to the borderline system.

Further according to another aspect of the present invention there is provided a method for generating a 3D-model of an urban environment where sub-areas are not overlapping.

Still further according to another aspect of the present invention there is provided a method for generating a 3D-model of an urban environment where the complementary area includes a transportation facility.

Even further according to another aspect of the present invention there is provided a method for generating a 3D-model of an urban environment where the transportation facilities includes any one of a road, a street, an avenue, a boulevard, a lane, a walkway, a path, a way, a highway, a tramway, and a railroad.

Yet further according to another aspect of the present invention there is provided a method for generating a 3D-model of an urban environment where the border line delineates an edge of a sidewalk and a pavement.

Additionally, according to another aspect of the present invention there is provided a method for generating a 3D-model of an urban environment where the edge includes any of a curb of the sidewalk, a curb of the road, and an interface between roadway and sidewalk.

According to yet another aspect of the present invention there is provided a method for generating a 3D-model of an urban environment where the edge includes the upper edge of a vertical element between roadway and sidewalk.

According to still another aspect of the present invention there is provided a method for generating a 3D-model of an urban environment additionally including the step of generating a 3D-model of the edge.

Also according to yet another aspect of the present invention there is provided a method for generating a 3D-model of an urban environment where the 3D-model of the edge is used to fuse together generated 3D-model of the sub-areas and generated 3D-model of the complementary area.

Further according to another aspect of the present invention there is provided a method for generating a 3D-model of an urban environment where a 3D-model of the sub-areas, and a 3D-model of the complementary area, conform to said 3D-model of said edge.

Yet further according to another aspect of the present invention there is provided a method for generating a 3D-model of an urban environment where the generated 3D-model of the complementary area creates a 3D-model of the plurality of border lines.

Still further according to another aspect of the present invention there is provided a method for fusing a plurality of 3D-models, where each of the 3D-models represents a sub-area, the method including identifying a border lines for each of the sub-area, where the border line substantially circumferences the sub-area, generating a 3D-model for each of the border lines, generating a 3D-model for an complementary area of the urban environment, the complementary area being external to the plurality of sub-areas and including the 3D-models of the border lines, and merging the 3D-models of the sub-area within the 3D-model of the complementary area, each within its respective 3D-models of the border line, to form a fused 3D-model of an urban environment.

Even further according to another aspect of the present invention there is provided a system for generating a 3D-model of an urban environment, the system including one or more computing machines including one or more software programs, where the software programs include a delineating unit enabling a user to delineate a border line enclosing a sub-area of the urban environment, a first 3D-modeling unit enabling a user to create a 3D-model of the border line, a second 3D-modeling unit enabling a user to create a 3D-model of a borderline system including a plurality of the border lines, a third 3D-modeling unit enabling a user to create a 3D-model of a sub-area enclosed by one of the border lines, a fourth 3D-modeling unit enabling a user to create a 3D-model of a complementary area, where the complementary area is a part of the urban environment not enclosed by any of the borderlines, and a fifth 3D-modeling unit enabling a user to create a 3D-model of the urban environment by fusing together the 3D-model of the sub-area with the 3D-model of the complementary area.

Additionally, according to yet another aspect of the present invention there is provided a computer program product, including a non-transitory computer-readable storage medium, and computer-readable program code embodied in the computer-readable storage medium, where the computer-readable program code is configured to cause a programmable processor to enable a user to carry out the steps of: delineating a border line enclosing a sub-area of the urban environment, creating a 3D-model of the border line, creating a 3D-model of a borderline system including a plurality of the border lines, creating a 3D-model of a sub-area enclosed by one of the border lines, creating a 3D-model of a complementary area, where the complementary area is a part of the urban environment not enclosed by any of the borderlines, and creating a 3D-model of the urban environment by fusing together the 3D-model of the sub-area with the 3D-model of the complementary area.

Further according to another aspect of the present invention there is provided a computer program product including a non-transitory computer-readable storage medium, and computer-readable program code embodied in the computer-readable storage medium, where the computer-readable program code is configured to cause a programmable processor to enable a user to carry out the step of delineating a closed border line, where the border line encloses a sub-area of the urban environment, where the border line does not include another border line, where the border line does not overlap another border line, and where the border line enables a user to perform the following actions: create a 3D-model of the border line, create a 3D-model of a borderline system including a plurality of the border lines, create a 3D-model of a sub-area enclosed by one of the border lines, create a 3D-model of a complementary area, where the complementary area is a part of the urban environment not enclosed by any of the borderlines, and create a 3D-model of the urban environment by fusing together the 3D-model of the sub-area with the 3D-model of the complementary area.

Yet further according to another aspect of the present invention there is provided a computer program product including a non-transitory computer-readable storage medium, and computer-readable program code embodied in the computer-readable storage medium, where the computer-readable program code is configured to cause a programmable processor to enable a user to carry out the step of: creating a 3D-model of the urban environment by fusing together a 3D-model of a sub-area of the urban environment with a 3D-model of a complementary area of the urban environment, where the sub-area and the complementary area share a boundary line, where the border line encloses the sub-area, where the border line separates between the sub-area and the complementary area, and where the border line is formed according to a plurality of ground elements of the urban environment.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified isometric illustration of a borderline system of an urban environment;

FIG. 2 is a simplified illustration of a vertical projection (or orthophoto) of the borderline system;

FIG. 3 is a simplified illustration of a side cross-section of an element of an urban environment having an edge of a sidewalk serving as a border line;

FIG. 4 is a simplified block diagram of a process for generating a 3D-model of an urban environment;

FIGS. 5A, 5B, 5C, 5D, 5E, 5F, 5G, 5H, and 5I, are simplified illustrations of vertical projection (orthophoto) views of sub-areas of the urban environment;

FIGS. 6A, 6B, 6C, 6D 6E, 6F, 6G, 6H, and 6I are simplified isometric views of the sub-areas of the urban environment;

FIG. 7 is a simplified isometric illustration of a 3D-model of the complementary area of the sub-areas of the urban environment;

FIG. 8 is a simplified orthophoto illustration of the complementary area;

FIG. 9 is a simplified isometric illustration of an urban environment;

FIG. 10 is a simplified illustration of an orthophoto of the urban environment of FIG. 9;

FIG. 11 is a simplified illustration of a system implementing the method for generating 3D-model of an urban environment; and

FIG. 12 is a simplified flow chart of a work flow using the system implementing the method for generating a 3D-model of an urban environment.

### DETAILED DESCRIPTION OF THE INVENTION

The present embodiments comprise a system and a method for producing a three dimensional (3D) model of a large-scale environment. This large-scale 3D-model is created by fusing together a plurality of 3D-models, each representing a part of the large-scale environment. The principles and operations of defining the parts of the large-scale environment, and fusing the respective plurality of 3D-models, according to the present invention may be better understood with reference to the following drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different drawings may use different scales and different scales can be used even within the same drawing, for example different scales for different views of the same object or different scales for the two adjacent objects.

The purpose of the present invention is to provide a 3D-model of a large physical entity or object. The entity or object can be any large physical object that may require multiple scanning producing a plurality of point clouds from which are converted to a plurality of 3D-models. Such large physical entity or object can be, for example, a building, a construction, a structure, an urban environment, etc.

The 3D-model of the entire entity or object is named herein a global 3D-model, a fused 3D-model, a merged 3D-model, a collective 3D-model, etc. This 3D-model is preferably created by fusing, merging, and/or aligning a plurality of partial or local 3D-models. A 3D-model is typically created from photogrammetry, from a point cloud, or from other means providing three dimensional data of at least some features of an object, as well as various combinations thereof.

Photogrammetry is typically based on a set of two dimensional photographic images of an object taken from two or more angles. The images can be taken simultaneously, such as in stereoscopy, or consecutively, such as typical with aerial photography.

Point-clouds are preferably created or collected by a 3D scanner, preferably a 3D laser scanner. Laser scanners are well known in the art. Typically, the local point-clouds are created by moving the scanner about (such as around and/or within) the object or entity. Other types of 3D scanners are also known and may be used by one or more embodiments of the present invention to create point-clouds. Such 3D scanners may use phase measurement laser scanner technology, structured-light 3D scanner using pattern projection technology, etc.

3D data, as referred to below, preferably include a variety of 2D and 3D measurements of urban structures including, orthophoto data, aerial imagery, ground level photogrammetry, laser scanning, measurements of orientation and inclination of the measuring devices, measurements of the travel distances of the measuring devices, GPS data, etc.

Hereinafter a large-scale urban environment is used as an example of a large physical entity or object. This large-scale urban environment is named urban environment for conciseness. In this document the term orthophoto may denote nadir photogrammetry or another method producing a vertical projection of a 3D ground object or a vertical projection of a 3D-model of a ground object.

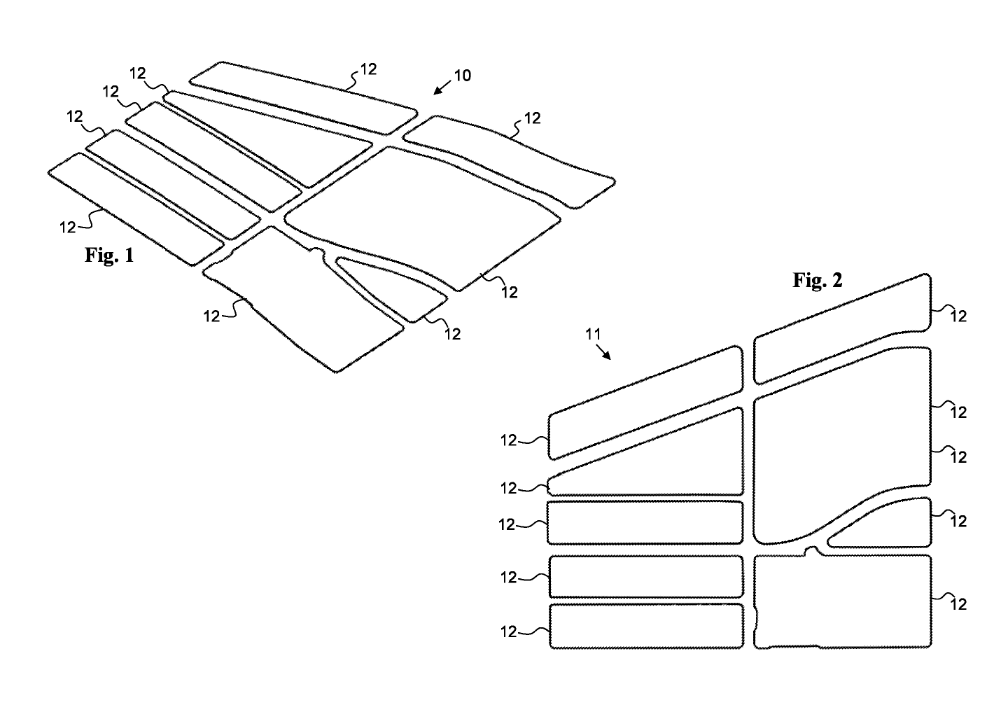

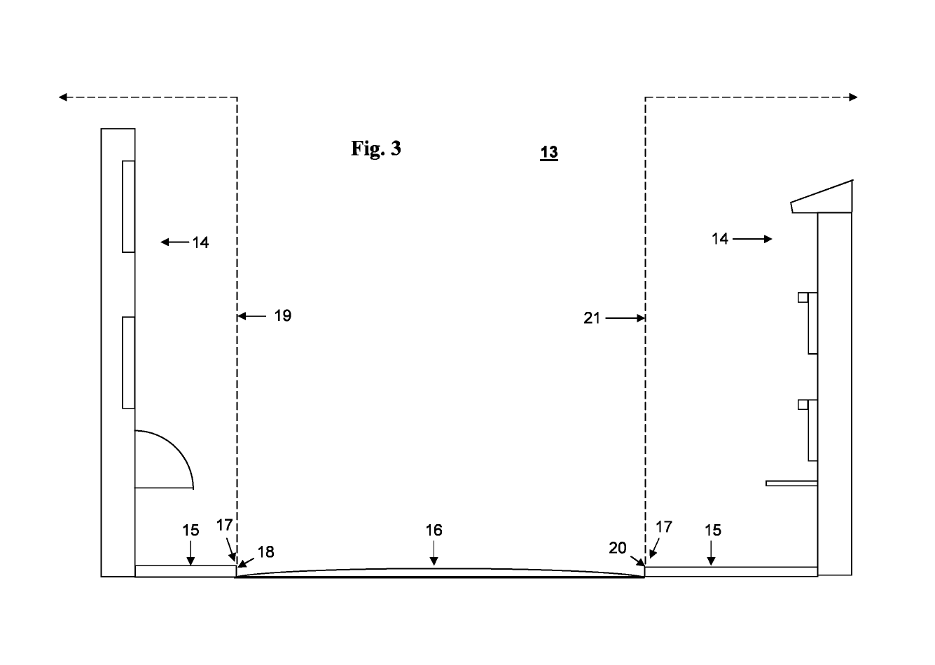

Reference is now made to FIG. 1, which is a simplified isometric illustration of a borderline system 10 of an urban environment, and to FIG. 2, which is a simplified illustration of a vertical projection (or orthophoto) 11 of the borderline system 10, according to a preferred embodiment of the present invention.

FIGS. 1 and 2 show an example of a borderline system 10 being applied to an urban environment. Borderline system 10 includes a plurality of borderlines 12. Each borderline 12 is preferably a closed 3D contour assigned with geographic coordinates whose projection onto a terrain surface delineates a well-defined geographic area. Hereinafter the area enclosed by a borderline is named “sub-area”. Borderlines 12 of borderline system 10 are preferably mutually exclusive in the sense that they 12 do not overlap or include each other (except where hierarchy is implemented). Borderline system 10 divides the urban environment into two parts:

The plurality of sub-areas included within borderlines 12.

A complementary area including the urban environment outside all borderlines 12.

A borderline 12 is therefore preferably a circumference of the sub-area, and a sub-area can be any part of the urban environment surrounded by, or enclosed within, a borderline 12.

As seen in FIGS. 1 and 2, the urban environment preferably includes three main parts:

The borderline system 10.

A collection of sub-areas, each sub-area defined by its respective borderline 12.

A complementary area entirely outside the sub-areas.

Therefore, borderlines 12 are separating the sub-areas from each other and the borderline system 10 separates the sub-areas from the complementary area. However, for practical reasons of 3D-modeling, a borderline 12 may be considered to belong to its respective sub-area, as well as to the complementary area.

Preferably, the complementary area includes (or coincides with) transportation facilities and the borderlines 12 are formed along the transportation facilities. Preferably, the transportation facilities include: roads, streets, avenues, boulevards, lanes, walkways, paths, ways, highways, tramways, railroads, etc. Preferably, a border line 12 designates an edge of a sidewalk (pavement) such as a curb or another type of interface between a roadway and a sidewalk.

The sub-areas are hereafter termed “city blocks” also, as typically their respective borderlines delineate one or more blocks of buildings. However, a sub-area may include a city garden, or a park, or a part of such city garden or park, or any combination of buildings, gardens and similar urban structures.

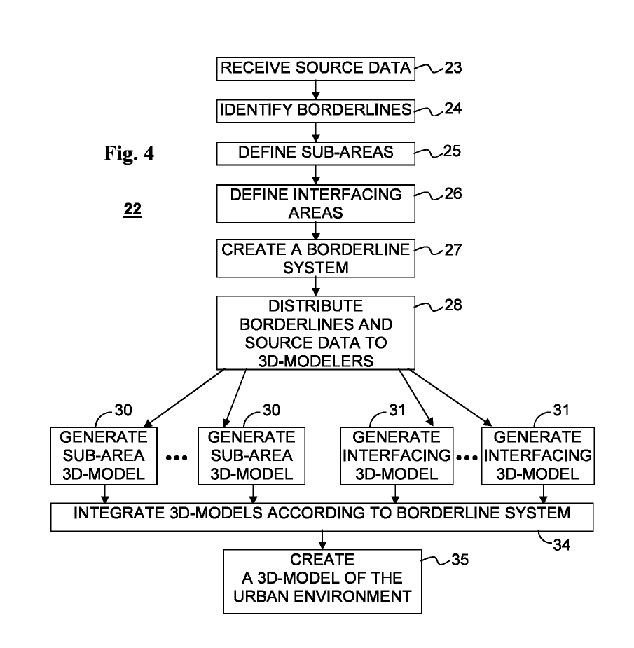

Reference is now made to FIG. 3, which is a simplified illustration of a side cross-section of an element of an urban environment having an edge of a sidewalk serving as a border line 12, according to a preferred embodiment of the present invention.

FIG. 3 shows a side view of a transportation facility 13 in the form of a street having buildings 14 at both sides, sidewalks 15 in front of buildings 14, and a road 16 between the sidewalks 15. Vertical sides of the sidewalks 15, between the sidewalk 15 and the road 16, form edges 17. Borderlines 12 of FIGS. 1 and 2 are typically formed along edges 17. The borderline for edges 17 designated by numeral 18 delineates a sub-area designated by numeral 19, and borderline 12 for edges 17 designated by numeral 20 delineates a sub-area designated by numeral 21. The road 16 would therefore belong to a complementary area.

It is appreciated that sidewalk edges may be broken or discontinuous and thus borderlines 12 may not necessarily coincide with sidewalk edges all along their contours. Alternatively, borderlines 12 may be formed along any distinguishable ground elements that delineate a closed contour of a sub-area. Therefore, borderlines 12 may coincide with any collection or combination of any distinguishable urban linear elements, including sidewalk curbs, lawn borders, walls, fences, river banks etc. that together form a closed contour around a sub-area. It is appreciated that borderlines 12 may be a virtual line drawn according to any plurality of ground level physical objects identified within the urban environment. These physical objects may be contiguous, or adjoining, or non-contiguous, having gaps between. Preferably, the borderline 12 delineates the upper edge of such physical object.

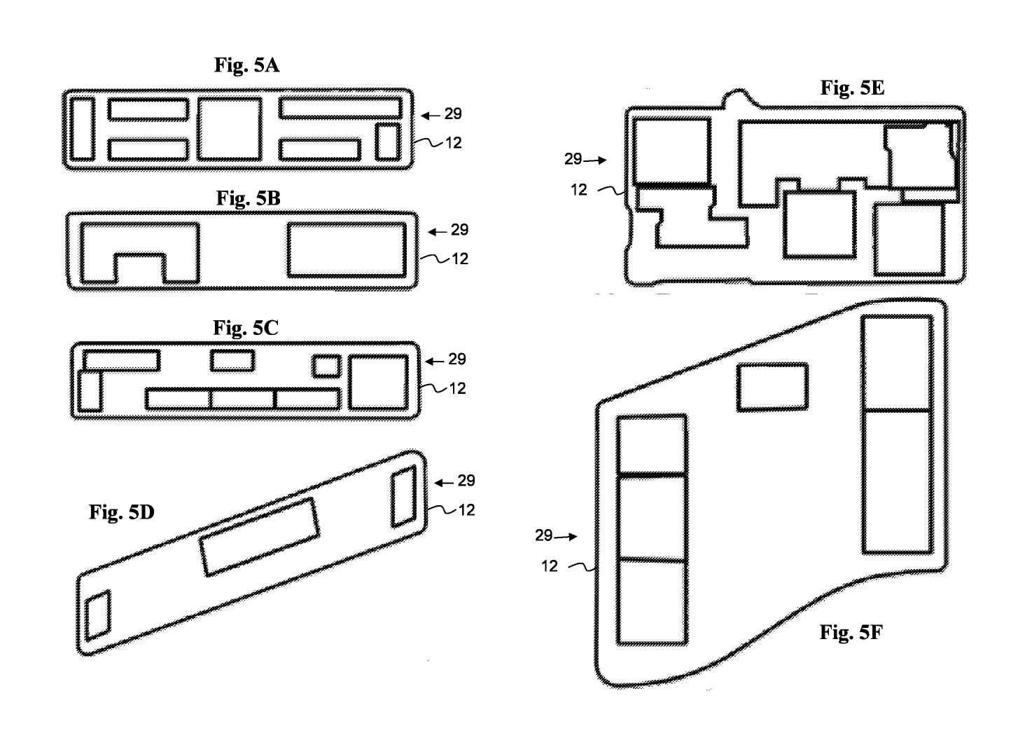

Reference is now made to FIG. 4, which is a simplified block diagram of a process 22 for generating a three dimensional (3D) model of an urban environment, according to a preferred embodiment of the present invention.

Process 22 is preferably implemented as a software program, executed by a computing facility, such as a computer, a network of computers, a network of servers and client devices, a computing cloud, etc. Process 22 preferably implements a method for generating a 3D-model of an urban environment as described herein, using a system for generating a 3D-model of an urban environment including the computing facility and software program discussed above. The users of this system are preferably a group of 3D-modeling specialists that together create the 3D-model of the urban environment from a collection of data sources. Process 22 preferably includes software units or software modules implementing the following steps. Preferably, each one or more of the steps below constitute such module or unit or sub-process.

Process 22 preferably begins with step 23 by receiving a collection of source data pertinent to an urban environment for which a 3D-model should be generated.

Data sources for the creation of a 3D-model of the urban environment may include orthophoto data of the urban environment, aerial photography, street level photography, street level laser scanning, GPS data, measurements of traveling distance, height, orientation, etc. Systems and methods for such measurements are known in the art and are described in the following patent applications, the contents of which are hereby incorporated by reference: US patent application 20080221843, U.S. Pat. No. 8,237,703 and U.S. provisional patent application 61/729,359.

Process 22 preferably proceeds to step 24 where one or more users analyze the source data to identify border lines such as border lines 12 of FIGS. 1 and 2. Preferably, the user uses an orthophoto, an aerial photography or a similar imagery of the urban environment to identify and select, or determine, the preferred border lines.

Process 22 preferably proceeds to steps 25 and 26 where one or more users define sub-areas within, or enclosed by, the border lines selected in step 24 and the complementary area selected in step 24. The concepts of border lines, sub-areas and complementary area are described above with reference to FIGS. 1 and 2. It is appreciated that the complementary area may include several areas, however, it is preferred to have only one complementary area.

Process 22 preferably proceeds to step 27 to create a borderline system such as borderline system 10 shown and described with reference to FIGS. 1 and 2.

It is appreciated that steps 23, 24, 25, 26, and 27 may be grouped together in various manners including as a single step.

Process 22 then preferably proceeds to step 28 to distribute the selected borderlines (and/or borderline system) with their respective source data to one or more users such as 3D-modelers. Preferably, each 3D-modeler receives a border line and source data pertinent to the sub-area enclosed by the border line, including the source data for the borderline itself. Possibly, a 3D-modeler may be allocated several border lines and sub-areas. Additionally, the border line system and the source data for the complementary area are distributed to one or more 3D-modelers.

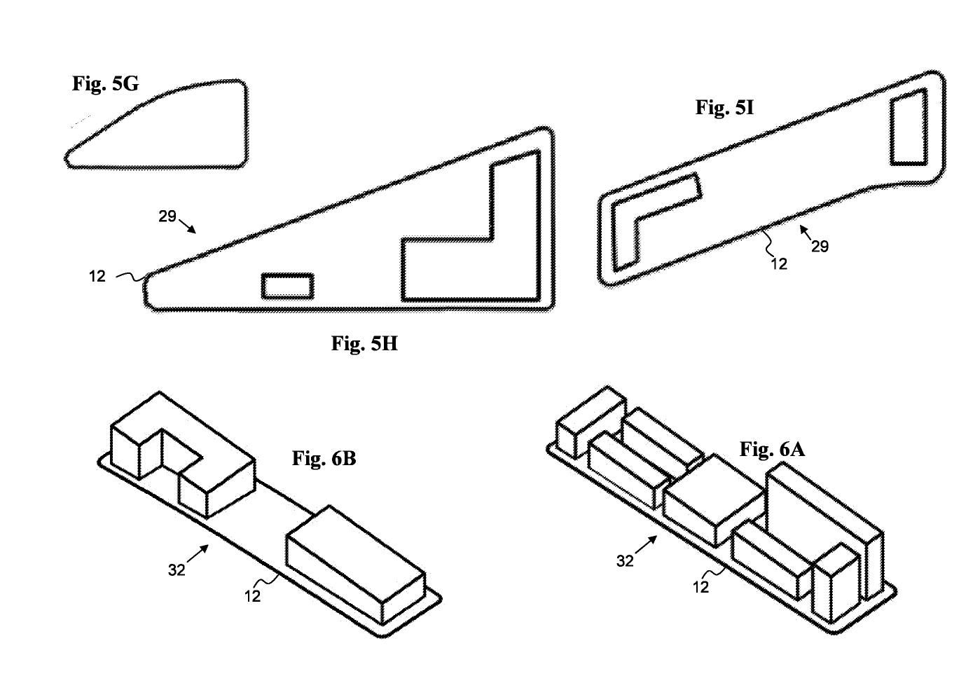

Reference is now made to FIG. 5A, FIG. 5B, FIG. 5C, FIG. 5D, FIG. 5E, FIG. 5F, FIG. 5G, FIG. 5H, and FIG. 5I, which are simplified illustration of vertical projection (orthophoto) views 29 of sub-areas, according to a preferred embodiment of the present invention.

The sub-areas of FIGS. 5A-5I and their respective border lines correspond to the borderlines 12 of FIGS. 1 and 2. FIGS. 5A-5I represent the source data and borderlines of their respective sub-areas distributed to the 3D-modelers in step 28. FIG. 2 represents the source data and border lines for the complementary area distributed the 3D-modeler in step 31.

Returning to FIG. 4, process 22 then preferably proceeds to steps 30 where 3D-modelers create 3D-models of their respective sub-areas (including their border lines), and to step(s) 31 where 3D-modelers create a 3D-model of the complementary area (including the border line system).

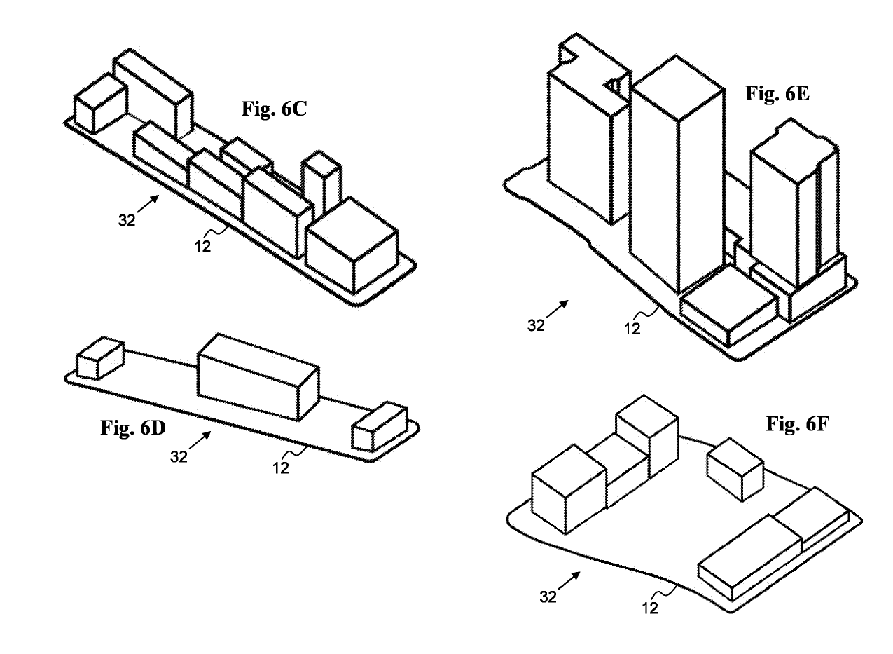

Reference is now made to FIG. 6A, FIG. 6B, FIG. 6C, FIG. 6D FIG. 6E, FIG. 6F, FIG. 6G, FIG. 6H, and FIG. 6I, which are simplified isometric views 32 of sub-areas according to a preferred embodiment of the present invention.

FIGS. 6A-6I correspond to FIGS. 5A-5I and their respective sub-areas and border lines. FIGS. 6A-6I represent the 3D-models of the sub-areas created by the 3D-modelers in steps 30.

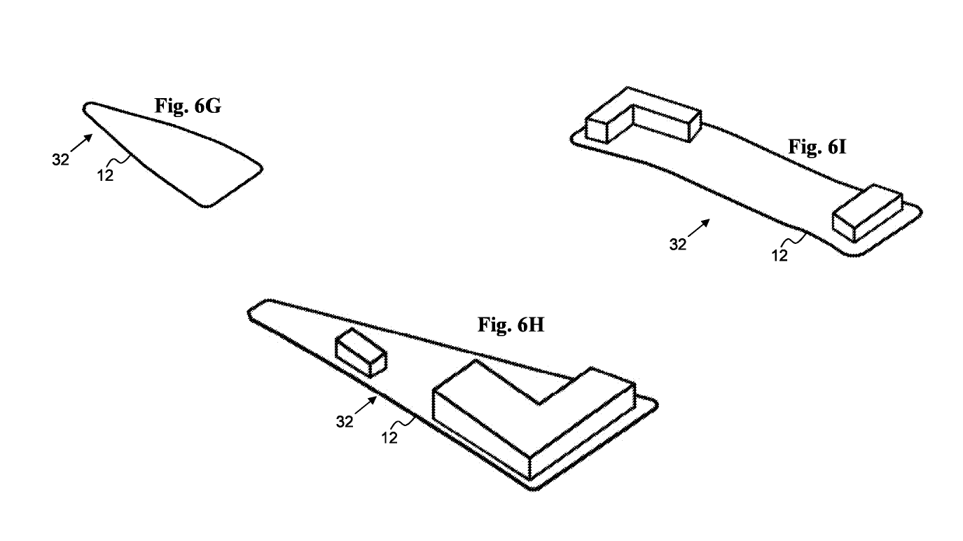

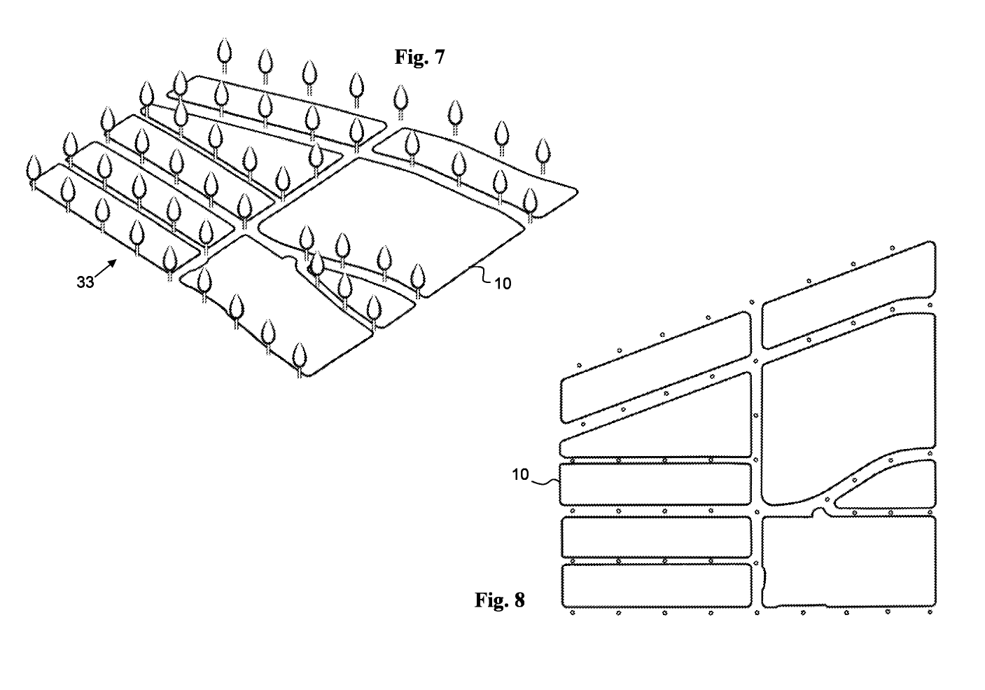

Reference is now made to FIG. 7, which is a simplified isometric illustration of a 3D-model 33 of the complementary area, and to FIG. 8, which is a simplified orthophoto illustration of the complementary area, according to a preferred embodiment of the present invention. FIG. 7 represents a 3D-model of the complementary area created by a 3D-modeler in step 31. FIG. 8 is an orthophoto of the 3D-model of the complementary area. As seen in FIG. 7, the 3D-model of the complementary area is created using the borderline system 10.

Returning to FIG. 4, process 22 then preferably proceeds to steps 34 and 35. In step 34 one or more 3D-modelers integrate the 3D-models of the sub-areas into the 3D-model of the complementary area. The integration is preferably performed by fitting the border lines of the 3D-models of the sub-areas into the respective border lines of the 3D-model of the complementary area. In step 35 an integrated model of the urban environment is generated.

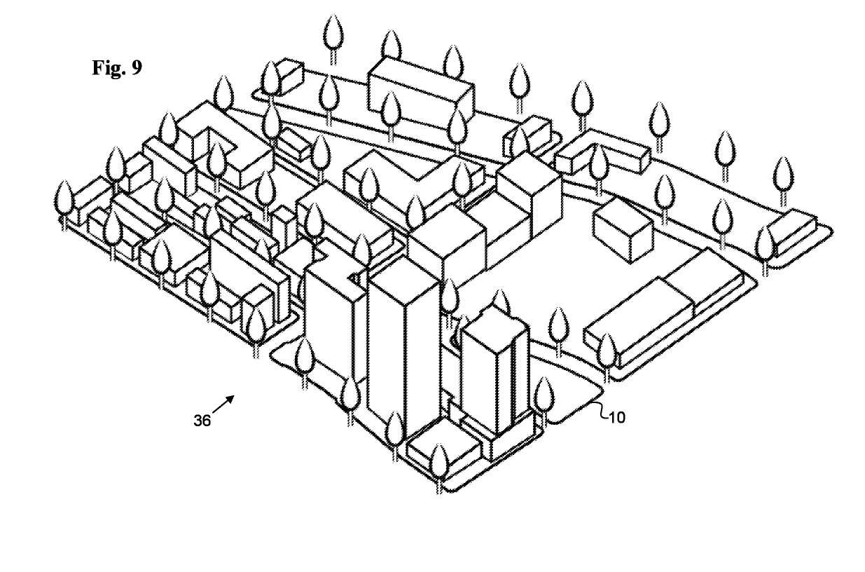

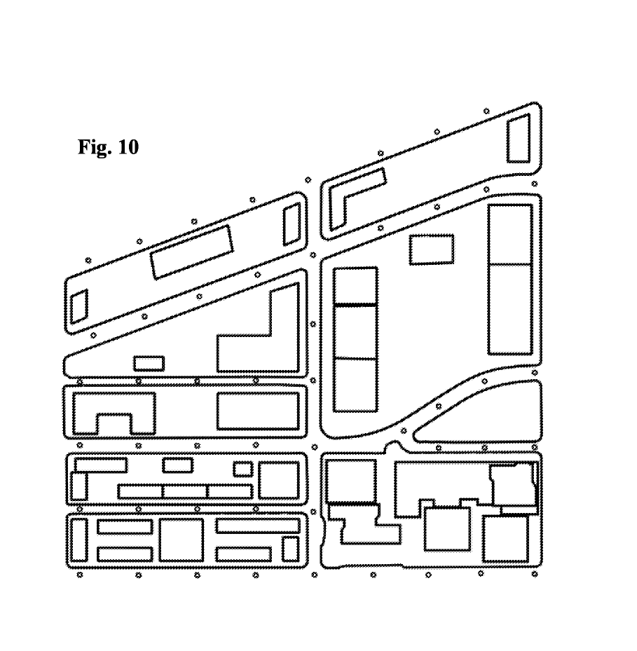

Reference is now made to FIG. 9 and FIG. 10. FIG. 9 is a simplified isometric illustration of an urban environment according to a preferred embodiment of the present invention. FIG. 10 is a simplified illustration of an orthophoto of the urban environment of FIG. 9, according to a preferred embodiment of the present invention.

The isometric illustration of FIG. 9 and the orthophoto of FIG. 10 are preferably derived from the 3D-model 36 of urban environment generated in step 35 of process 22. Therefore, FIGS. 9 and 10 illustrate respective isometric and orthophoto views of a 3D-model integrating the 3D-models of the sub-areas and the 3D-model of the complementary area. Preferably, the borderlines of the sub-areas are fitted with their respective border lines of the complementary area. It is noted that proper merging of the 3D-models of the sub-areas into the 3D-model of the complementary area forms a continuous and seamless 3D-model of the entire urban environment.

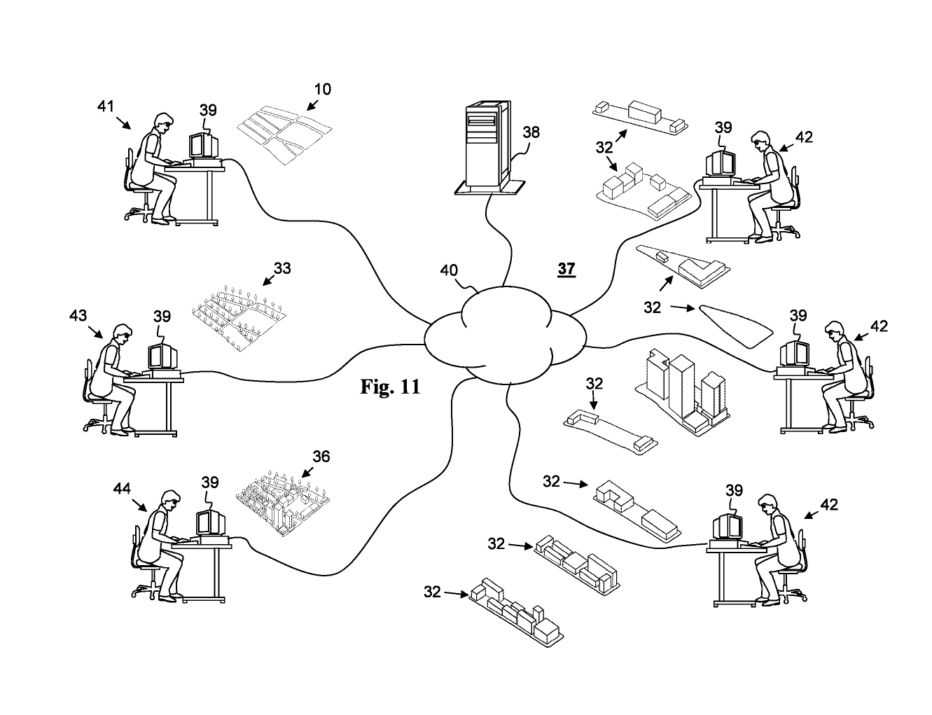

Reference is now made to FIG. 11, which is a simplified illustration of a system 37 implementing the method for generating a 3D-model of an urban environment according to a preferred embodiment of the present invention.

As shown in FIG. 11, system 37 preferably includes one or more servers 38, and one or more workstations 39, preferably connected over a network 40. Servers 38 preferably stores the software program implementing process 22 as described above, a collection of data sources for the urban environment as described above, the borderlines 12 and borderline system 10, the 3D-models 32 described above, as well as the 3D-model 36 of the urban environment.

As shown in FIG. 11, user 41 defined the borderlines (such as borderlines 12 of FIG. 1), creates borderline system (such as borderline system 10 of FIG. 1), and distributes the work between 3D-modelers 42. 3D-modelers 42 then create 3D-models 32 of sub-areas and one or more 3D-modelers 43 create a 3D-model 33 of the complementary area. Thereafter user 44 integrates the 3D-models 32 of sub-areas and the 3D-model 33 of the complementary area by fitting together their respective borderlines.

As described above, system 37 implements a method for generating a 3D-model of an urban environment. The method includes four main steps:

Identifying a plurality of 3D border lines, where each border line substantially delineates a sub-area within the urban environment. The sub-areas are preferably not overlapping each other.

Generating a 3D-model for each sub-area.

Generating a 3D-model for the complementary area.

Automatically merging together the 3D-models of the sub-areas with the 3D-model of the complementary area. The merging is preferably based on the predefined set of 3D border lines (namely the borderline system). The merging forms a 3D-model of the entire urban environment without any discontinuities and seam lines.

The sub-division of the urban environment to non-overlapping sub-areas becomes a basis for organizing the work flow of 3D-modeling process in which 3D-models of individual sub-areas can be independently developed by different 3D-modelers. The 3D-modeling may therefore be done at different times and/or at different geographic locations, yet preserving the ability at the end of the process to automatically stitch together the 3D-models of the sub-areas with the 3D-model of the complementary area.

The complementary area preferably includes roads and other motorcar and pedestrian traffic facilities, like a street, an avenue, a boulevard, a lane, a walkway, a highway, a tramway, and a railroad.

The 3D border lines preferably delineate the upper edge of a sidewalk (pavement, curb). The above mentioned method preferably includes a step of generating a 3D-model of the upper edges. Generating a 3D-model of the upper edges is preferably based on fusion of high resolution air and ground-borne remote sensing data (laser and image) and ground survey measurements to ensure its highest possible precision. The precision of such method of generating 3D-models of the upper edges prevents propagation of errors in automated merging together the 3D-models of the sub-areas with the 3D-model of the complementary area. Thus forming a 3D-model of the entire urban environment with the highest possible large-scale (global) precision.

Hence, the following four-step method is used for fusing a plurality of 3D-models, where each of the 3D-models represents a sub-area:

Identifying a border line for each of the sub-areas, where the border line substantially circumferences the sub-area.

Generating a 3D-model for each of the border lines.

Generating a 3D-model for a complementary area of the urban environment, base on, and/or including, the 3D-models of said border lines. The complementary area being external to the sub-areas.

Arranging the 3D-models of the sub-areas within the 3D-model of the complementary area, each within its respective 3D-models of border line, to form a fused 3D-model of the urban environment.

It is appreciated that the method and the system for as described above are used for generating a three-dimensional model of an urban environment or a similar large structure using a structural hierarchy. The structural hierarchy includes at least one large object and a plurality of smaller objects that are embedded within the large object. The large object is known herein as the complementary area and the smaller objects are known herein as the sub-areas. Preferably, the sub-areas are not overlapping, and are separated from each other by the complementary area.

It is appreciated that the hierarchy may include three or more layers. For example, a first layer including a large and relatively coarse complementary area, a second layer including a plurality of smaller complementary areas embedded within the first layer, and a third layer including the sub-areas. The components of each layer are preferably separated from each other by the layer above.

Preferably, the complementary area includes large continuous objects such as urban transportation facilities, pipes, electric grid, etc. Preferably, each of the sub-areas is defined, and/or delineated, by a substantially continuous borderline, or a contour line, enclosing and/or circumferencing the sub-area. Preferably, the borderline follows a physical demarcation, such as an edge of a road or the edge of a sidewalk. For example, the upper edge of the vertical surface between the road, (or the gutter, or the curb) and the raised sidewalk.

It is appreciated that generating a three-dimensional model of an urban environment according to the method described above includes:

Defining a borderline system (or lattice, such as shown and described with reference to FIG. 2).

Creating a 3D-model of the borderline system (such as element 10 of FIG. 1).

Creating a 3D-model of the complementary area (such as element 33 of FIG. 7) based on the 3D-model of the borderline system.

Creating a plurality of 3D-models for the sub-areas (such as elements 32 of FIGS. 6A-6H).

Embedding 3D-models of the sub-areas within the 3D-model of the complementary area by fitting their borderlines into their respective borderline lanes of the 3D-model of the complementary area (or the 3D-model of the borderline system).

If the structural hierarchy includes more than two layers the process above is repeated for each pair of consecutive levels, preferably starting with the largest level.

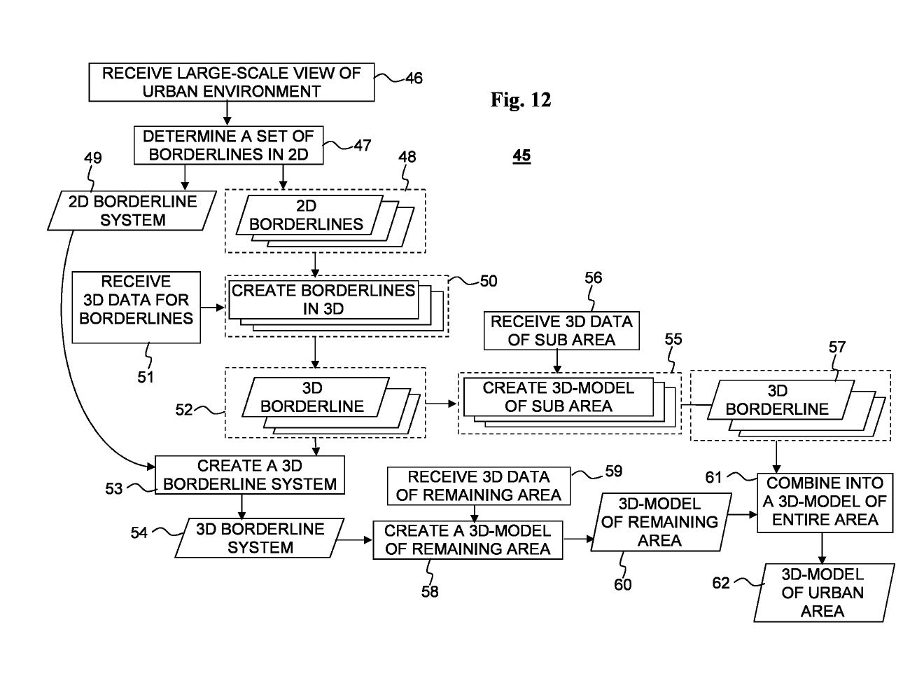

Reference is now made to FIG. 12, which is a simplified flow chart of a work flow 45 using system 37, according to a preferred embodiment of the present invention.

Work flow 45 preferably implementing the method for generating a 3D-model of an urban environment as shown and described with reference to FIGS. 1 to 11. Work flow 45 preferably starts with step 46 by receiving a large-scale view of the urban environment, such as an aerial photography, an orthophoto, etc.

Work flow 45 preferably proceeds with step 47 where a user determines the plurality of borderlines in 2D (48) and thus creates a 2D borderline system (49).

Work flow 45 preferably proceeds with step 50 where the 2D borderlines 48 are distributed to one or more 3D-modelers. The 3D-modeleres receive 3D data (51) of the respective borderlines and create thereform 3D-models of the borderlines (52).

Work flow 45 preferably proceeds with step 53 where one or more 3D-modelers receive the 2D borderline system 49 and the 3D-models of the borderlines 52 and create a 3D-model of the borderline system (54).

Work flow 45 preferably also executes step 55 where a plurality of 3D modelers receive one or more 3D-models of the borderlines 52 with its respective 3D data (56) of the respective sub-area, and creates a 3D-model of the sub-area (57) whothin the respective 3D-model borderline. Hence, a plurality of sub-area 3D-models 57 is created.

Work flow 45 preferably also executes step 58 where one or more 3D-modelers receive the 3D-model of the borderline system 54 and 3D data of the complementary area (59), and create a 3D-model 60 of the complementary area.

It is appreciated that steps 53 and 55, and/or steps 58 and 55, are optionally and preferably executed in parallel.

Work flow 45 preferably proceeds with step 61 where one or more a 3D-modelers combine the sub-area 3D-models 57 into the 3D-model of the complementary area 60, thus creating a 3D-model 62 of the entire urban environment. Preferably, the combination of the sub-area 3D-models 57 and the 3D-model 60 of the complementary area is executed by matching, or fusing together, the 3D-models 52 of their respective borderlines. Thus the 3D-model 62 of the urban environment is a fused 3D-model of the of the sub-area 3D-models 57, the 3D-model 60 of the complementary area and the 3D-model 54 of the borderline system.

It is appreciated that the method for generating a 3D-model of an urban environment as described above includes a division of the urban environment to non-overlapping sub-areas (city blocks). This division becomes the basis for organizing the work-flow of 3D-modeling process in which 3D-models of individual sub-areas can be independently developed by different 3D-modelers. Furthermore, the 3D-modeling can be done at different times and/or at different geographic locations. Moreover, this method preserves the ability at the end of the process to automatically stitch together the 3D-models of the sub-areas with the 3D-model of the remaining area (the complementary area) without any discontinuities and seam lines.

As described above, border lines 12 are typically drawn along or between distinguishable ground elements that delineate a closed contour of a sub-area. The method described above may be described in an alternative manner to include the following steps:

Indicating outstanding ground points or lines of the urban environment.

Drawing borderlines along or between these points and lines so that each borderline encloses and separates a sub-area within the urban area.

Identifying the rest of the urban areas the complementary area.

Producing 3D-models of the sub-areas and the complementary area using the indicated outstanding ground points or lines as anchor points (or lines).

Aligning 3D-models of sub-areas within the 3D-model of the complementary area using respective anchor points and lines.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for generating a 3D-model of an urban environment, said method comprising the steps of:
identifying a plurality of border lines, wherein each border line delineates an a sub-area of said urban environment;
generating a 3D-model for a sub-area enclosed by one of said border lines;
generating a 3D-model for complementary area, wherein said complementary area is a part of said urban environment not enclosed by any of said borderlines; and
merging said 3D-model of said sub-area within said 3D-model of said complementary area to form said 3D-model of said urban environment.

2. The method for generating a 3D-model of an urban environment according to claim 1 wherein said border line is drawn according to a plurality of ground level physical objects identified within said urban environment.

3. The method for generating a 3D-model of an urban environment according to claim 1 additionally comprising a step of generating a 3D-model of a borderline system, wherein said borderline system comprises said plurality of border lines.

4. The method for generating a 3D-model of an urban environment according to claim 3 wherein said 3D-model for a sub-area of said urban environment is generated according to said borderline enclosing said sub-area and wherein said borderline is part of said 3D-model of said borderline system.

5. The method for generating a 3D-model of an urban environment according to claim 3 wherein said 3D-model of said complementary area of said urban environment is generated according to said borderline system.

6. The method for generating a 3D-model of an urban environment according to claim 1 wherein said plurality of sub-areas are not overlapping.

7. The method for generating a 3D-model of an urban environment according to claim 1 wherein said complementary area comprises a transportation facility.

8. The method for generating a 3D-model of an urban environment according to claim 7 wherein said transportation facilities comprises at least on of: a road, a street, an avenue, a boulevard, a lane, a walkway, a path, a way, a highway, a tramway, and a railroad.

9. The method for generating a 3D-model of an urban environment according to claim 1 wherein said at least one of said border lines delineates an edge of at least one of a sidewalk and a pavement.

10. The method for generating a 3D-model of an urban environment according to claim 9 wherein said edge comprises at least one of a curb of said sidewalk, a curb of said road, and an interface between roadway and sidewalk.

11. The method for generating a 3D-model of an urban environment according to claim 9 wherein said edge comprises the upper edge of a vertical element between roadway and sidewalk.

12. The method for generating a 3D-model of an urban environment according to claim 9 additionally comprising the step of generating a 3D-model of said edge.

13. The method for generating a 3D-model of an urban environment according to claim 12 wherein said 3D-model of said edge is used to fuse together generated 3D-model of said sub-areas, and generated 3D-model of said complementary area.

14. The method for generating a 3D-model of an urban environment according to claim 12 wherein a 3D-model of said sub-areas, and a 3D-model of said complementary area, conform to said 3D-model of said edge.

15. The method for generating a 3D-model of an urban environment according to claim 13 wherein said generated 3D-model of said complementary area creates a 3D-model of said plurality of border lines.

16. A method for fusing a plurality of 3D-models, where each of said 3D-models represents a sub-area, said method comprising the steps of:
identifying a border lines for each of said sub-area, wherein said border line substantially circumferences said sub-area;
generating a 3D-model for each of said border lines;
generating a 3D-model for an complementary area of said urban environment, said complementary area being external to said plurality of sub-areas and including said 3D-models of said border lines; and
merging said 3D-models of said sub-area within said 3D-model of said complementary area, each within its respective 3D-models of said border line, to form a fused 3D-model of an urban environment.

17. A system for generating a 3D-model of an urban environment, said system comprising at least one computing machine comprising software program comprising:
a delineating unit enabling a user to delineate a border line enclosing a sub-area of said urban environment;
a first 3D-modeling unit enabling a user to create a 3D-model of said border line;
a second 3D-modeling unit enabling a user to create a 3D-model of a borderline system comprising a plurality of said border lines;
a third 3D-modeling unit enabling a user to create a 3D-model of a sub-area enclosed by one of said border lines;
a fourth 3D-modeling unit enabling a user to create a 3D-model of a complementary area, wherein said complementary area is a part of said urban environment not enclosed by any of said borderlines; and
a fifth 3D-modeling unit enabling a user to create a 3D-model of said urban environment by fusing together said 3D-model of said sub-area with said 3D-model of said complementary area.

18. A computer program product comprising a non-transitory computer-readable storage medium; and computer-readable program code embodied in said computer-readable storage medium, wherein the computer-readable program code is configured to cause a programmable processor to enable a user to carry out the following steps:
delineating a border line enclosing a sub-area of said urban environment;
creating a 3D-model of said border line;
creating a 3D-model of a borderline system comprising a plurality of said border lines;
creating a 3D-model of a sub-area enclosed by one of said border lines;
creating a 3D-model of a complementary area, wherein said complementary area is a part of said urban environment not enclosed by any of said borderlines; and
creating a 3D-model of said urban environment by fusing together said 3D-model of said sub-area with said 3D-model of said complementary area.

19. A computer program product comprising a non-transitory computer-readable storage medium; and computer-readable program code embodied in said computer-readable storage medium, wherein the computer-readable program code is configured to cause a programmable processor to enable a user to carry out the step of:
delineating a closed border line, wherein said border line encloses a sub-area of said urban environment, wherein said border line does not include another border line, wherein said border line does not overlap another border line, and wherein said border line enables a user to perform at least one of the following actions:
create a 3D-model of said border line;
create a 3D-model of a borderline system comprising a plurality of said border lines;
create a 3D-model of a sub-area enclosed by one of said border lines;
create a 3D-model of a complementary area, wherein said complementary area is a part of said urban environment not enclosed by any of said borderlines; and
create a 3D-model of said urban environment by fusing together said 3D-model of said sub-area with said 3D-model of said complementary area.

20. A computer program product comprising a non-transitory computer-readable storage medium; and computer-readable program code embodied in said computer-readable storage medium, wherein the computer-readable program code is configured to cause a programmable processor to enable a user to carry out the step of:
creating a 3D-model of said urban environment by fusing together a 3D-model of a sub-area of said urban environment with a 3D-model of a complementary area of said urban environment,
wherein said sub-area and said complementary area share a boundary line,
wherein said border line encloses said sub-area,
wherein said border line separates between said sub-area and said complementary area, and
wherein said border line is formed according to a plurality of ground elements of said urban environment.
